(19) United States
(12) Patent Application Publication
(10) Pub. No.: US 2011/0123309 A1
(43) Pub. Date: May 26, 2011

(54) REPLACEMENT STATION FOR THE TRACTION BATTERIES OF ELECTRIC VEHICLES

(75) Inventors: PETER BERDELLE-HILGE, KONSTANZ (DE); HOLGER SCHERERZ, REHFELDE (DE)

(73) Assignee: SIEMENS AKTIENGESELLSCHAFT, MUENCHEN (DE)

(21) Appl. No.: 12/948,413

(22) Filed: Nov. 17, 2010

(30) Foreign Application Priority Data
Nov. 17, 2009 (DE) 10 2009 053 358.3

(51) Int. Cl. B60S 5/06; B60K 1/04; B65G 67/02

(52) U.S. Cl. 414/800; 104/34

(57) ABSTRACT

A replacement station for the traction batteries of electric vehicles, preferably of passenger vehicles, which are arranged such that they can be replaced from underneath, alongside a vehicle axis in the direction of travel, in the floor area of the electric vehicle. In order to replace the traction battery, the electric vehicle is positioned, guided by tracks, above a hatch which is provided in the floor of the replacement station, and the traction battery is replaced through the hatch. In order to considerably minimize the total time required for completely automatic replacement of the traction battery without any disturbances, and to maintain a high safety standard in operation during the process, the track guidance guides at least those wheels which are arranged on one longitudinal side of the electric vehicle and in that, during track guidance, the electric vehicle is moved automatically by a controlled external drive, which acts on the electric vehicle.

### CROSS-REFERENCE TO RELATED APPLICATION

This application claims the priority, under 35 U.S.C. §119, of German patent application DE 10 2009 053 358.3, filed Nov. 17, 2009; the prior application is herewith incorporated by reference in its entirety.

### BACKGROUND OF THE INVENTION

### Field of the Invention

The invention relates to a replacement station for the traction batteries of electric vehicles, preferably of passenger vehicles, which are arranged such that they can be replaced from underneath, alongside a vehicle axis in the direction of travel, in the floor area of the electric vehicle. In order to replace the traction battery, the electric vehicle can be positioned, guided by tracks, above a hatch which is provided in the floor of the replacement station. The traction battery is then replaced through the hatch.

The increasing efforts to save fossil energy sources and environmental protection reasons are leading to the introduction of electric vehicles on a large scale for individual transport, necessitating intelligent systems which will make it possible to considerably increase the previously restricted range of electrically powered vehicles. At the moment, vehicle range is considerably restricted by the limited storage capacities of the traction batteries used, in comparison to vehicles with internal combustion engines. Furthermore, at the end of their range, drained traction batteries require several hours to be recharged, and the unavailability of the vehicle resulting from this, even in the case of traction batteries with a rapid charging capability, is extremely disturbing, and is leading to the market reacting to pure electric vehicles with some restraint.

Instead of this, hybrid vehicles are more frequently being used which in addition to the electrical drive, also have internal combustion engines which. Although the internal combustion engines increase the range of the vehicles, they still do not shorten the time to charge the traction batteries.

In order to make electric vehicles more attractive for the users, and to avoid the described disadvantages, it has already been proposed that the time-consuming charging processes for the traction batteries be dispensed with and that, instead of this, the drained traction batteries be replaced by charged traction batteries. Systems such as these for replacement of traction batteries have already been known for a very long time, and were even used in the early twentieth century (cf. U.S. Pat. No. 1,362,019). Other replacement stations for traction batteries for electric vehicles are described in U.S. Pat. No. 5,612,606 and in German published patent application DE 42 29 687 A1.

The last-mentioned document describes an automatic battery replacement station in which the electrically powered vehicles are positioned using a parking aid. The traction battery, which is arranged under the chassis, is then released by means of a handling apparatus and is lowered below the floor level in order to pass it by lateral movement under the floor to a charging and supply station. Already charged traction batteries are taken from a shelf storage system associated with the battery replacement station, are passed back on the return route, and are reinserted into the vehicle by means of the handling apparatus. It is intended to be possible to operate the known battery replacement station partially automatically.

When drained traction batteries are replaced in replacement stations of the described type, the total time required between the electric vehicle entering the station and leaving the station with a full traction battery is a critical factor for the attractiveness of a system such as this. This time is influenced not only by the pure process of replacing the traction battery but also by the additional times which are required, for example, for the entrance of the electric vehicle into the replacement station, and for positioning in the replacement station. Rapid central positioning of the electric vehicle is therefore just as important as the positioning accuracy of the replacement apparatus under the traction battery, which is also critical for fully automatic replacement, in particular without any disturbances, of the traction battery.

Although DE 42 29 687 A1 has already proposed a parking aid for the vehicle in the form of track grooves as known from lifting platforms and assembly pits, this, however, does not take into account the driving skill of the vehicle drivers or of the widely differing dimensions, in particular track widths and tire widths, of modern motor vehicles. Since, in order to increase the capacity, traction batteries are frequently very physically large and frequently occupy virtually the entire width of the electric vehicle, this additionally exacerbates the handling of the traction batteries, which are arranged under the vehicle and have to be removed through installation hatches, and the known battery replacement station does not take account of this. Furthermore, the known station ignores the safety aspects during replacement of the traction batteries through a hatch, under which there is a deep shaft which must be opened in order to replace the traction batteries.

### SUMMARY OF THE INVENTION

It is accordingly an object of the invention to provide a change station which overcomes a variety of disadvantages of the heretofore-known devices and methods of this general type and which provides for a replacement station of this generic type for the traction batteries of electric vehicles such that they can be handled safely and such that the total time required to replace the traction battery, in a fully automatic operation without any disturbances, calculated from the entrance to the exit of the electric vehicle, is substantially and considerably minimized.

With the foregoing and other objects in view there is provided, in accordance with the invention, a replacement station for exchanging traction batteries of electric vehicles, wherein the batteries are arranged for replacement from underneath the vehicle, alongside a vehicle axis in a direction of travel, in a floor area of the electric vehicle, the replacement station comprising:

a hatch provided in a floor of the replacement station and formed to have the electric vehicle disposed thereabove;

a track guidance system for guiding the vehicle during positioning above said hatch, said track guidance being configured to guide at least those wheels that are arranged on one longitudinal side of the electric vehicle;

a controlled external drive acting on the electric vehicle, at least during track guidance, for automatically moving the electric vehicle; and

wherein the traction battery is replaced through said hatch after the vehicle has been positioned.

In other words, the objects of the invention are achieved with a replacement station that has a track guidance system that guides at least those wheels which are arranged on one longitudinal side of the electric vehicle and in that, at least during track guidance, the electric vehicle is moved automatically by a controlled external drive, which acts on the electric vehicle. Since the driver of the electric vehicle no longer has to be involved in the process of moving and braking the vehicle, because the external drive carries out this function, this allows safe automatic operation, independently of possible errors by unskilled drivers.

If, according to one refinement of the invention, the external drive is in the form of a towing chain, which acts on the wheels of the electric vehicle driving them forward in a similar manner to the towing chain in a drive-through car wash, and which transports the electric vehicle with the traction battery exactly to a position above the hatch, this allows the electric vehicle to be aligned quickly and without disturbances.

According to one particularly advantageous refinement of the invention, the track guidance within the replacement station is adjustable laterally with respect to the longitudinal axis of the electric vehicle, with respect to the wheel width and/or track width of the electric vehicle, such that the traction battery of the electric vehicle can be positioned centrally above the hatch, irrespective of its wheel width and/or track width. The invention offers a solution which takes account of the widely differing driving capabilities of the car drivers on the one hand and the different tire width of a car type, and/or different track and axle separations of different car types.

Preferably, the track guidance guides at least the wheels which are arranged on one longitudinal side of the electric vehicle in which case, according to a further refinement of the invention, the track guide is in the form of a guide rail with side guides on both sides, to which the flank areas of the guided wheels can be applied. In this way, at least the front wheel and the rear wheel on one vehicle side are aligned in a defined lateral position with respect to the longitudinal plane in which the hatch for replacement of the traction battery is located. The alignment of the vehicles with respect to the hatch can be designed appropriately by moving the track guide and/or side guide transversally with respect to its own longitudinal axis.

One problem with track guides for electric vehicles is that the tire width can vary greatly even between vehicles which are physically the same. In order nevertheless to achieve a defined alignment with respect to the hatch, the invention proposes that the lateral distance between the side guides on both sides can be set to the width of the wheels or of the tires.

Preferably, the track guidance and/or the side guide are/is set laterally on the basis of the already known vehicle dimension data and the already known position of the traction battery in the electric vehicle. The vehicle data can either be stored in the replacement station and can be called up by identification of the vehicle. Alternatively, according to the invention, before the electric vehicle is moved into the replacement station, the vehicle dimension data is recorded and is entered in a computer which controls the matching of the track guidance to the individual dimensions of the electric vehicle.

In one development of the invention, aids are provided for initial positioning of the electric vehicle in front of the track guide. These aids, in addition to known visual guidance aids when driving the vehicle into the replacement station, can in the simplest case be represented by funnel-shaped widened areas at the start of the track guide or, according to another feature of the invention, may be in the form of movement platforms guided on the floor, on which the stationary electric vehicle can be moved by lateral movement of the platforms to a position which corresponds to the entrance position into the track guide. These aids mean that the electric vehicle need not be positioned very accurately initially; this is because the alignment is carried out by these aids. The correct position is always defined from the position of the traction battery with respect to the replacement mechanism.

A fully automatic replacement station must be subject to relatively stringent safety requirements in order to prevent people from being injured during the replacement process. In particular, the hatch should be closed at least whenever no electric vehicle is above it, in order that no object or living being, but in particular no person, can fall into the pit of the handling apparatus. The size required for the installation opening additionally makes it necessary to have the capability to drive over at least sub-areas of the closed flap. A further feature of the invention accordingly provides that the hatch is closed, and can possibly be driven on, before the positioning of the electric vehicle, and can be opened once the electric vehicle has been positioned exactly above the hatch.

For this purpose, the invention provides that the hatch can be closed by a plurality of flaps, which can pivot about respective horizontal pivoting axes, which can be opened as required for replacement of the traction battery, as soon as the electric vehicle is in the exactly aligned position above the hatch.

The required size of the hatch necessitates safety precautions against unauthorized access. Without such precautions, it would be possible for gaps to remain between the vehicle and the hatch even when vehicles are located in the replacement position, through which children, animals or objects could fall into the pit. In order to prevent this, according to the invention, edge areas of the hatch form fence-like protection (i.e., a protective fence) when the pivoted flaps are in the open position.

The flaps are preferably designed such that subsections of the pivoted flaps which project upward above the floor level form the protective fence for the edge areas of the hatch when in their open positions. This ensures that the fence-like protection is formed naturally as soon as the flap is opened.

Depending on the type of vehicle and battery in use, the traction battery is located between the axles of the vehicle, or else shortly behind the rear axle. In many cases, the width of the traction battery is greater than the distance between the insides of the wheels on both sides. In order to replace the drained traction battery, the open hatch must have an unobstructed width which is greater than the track width, and this means that it is necessary to be able to drive the electric vehicle at least over sub-areas of the closed hatch. In order to make this possible, it is proposed that if the hatch width extends into the driving track of the electric vehicle, flaps are provided which can be moved over on both sides in the edge area of the hatch and can be pivoted about pivoting axes, which are arranged parallel to the vehicle longitudinal direction, after said flaps have been moved over and before the replacement of the traction battery.

In order to drive over them, when the flaps are closed, their upper faces each form a flat movement path for the electric vehicle, and in that, at least that area of the lower faces of each of the two flaps facing the edge of the hatch is in the form of a cylindrical segment, whose longitudinal center axis in each case coincides with the pivoting axis of the flap. When the flap is being pivoted to the open position of the hatch, that cylindrical segment which faces outward is pivoted upward, and forms the fence-like protection for the opening of the hatch. The cylindrical segment safely closes the gap which remains after the flap has been pivoted, because of the separation required between the pivoting axis and the edge of the hatch, and keeps this gap closed even during the pivoting movement, such that no object can be trapped, even during pivoting.

In one advantageous refinement of the invention, at least one and preferably two further flaps, which can pivot, is or are provided in order to close the hatch, whose pivoting axes which run parallel to the edge area of the hatch and transversely with respect to the vehicle longitudinal axis are positioned with respect to the flap or flaps such that a subsection of each flap projects above the floor level in the immediate edge area of the hatch, when pivoted to the open position, and forms the fence-like protection for the hatch. By splitting the flaps into those flaps whose pivoting axes run in the vehicle longitudinal direction and those whose pivoting axes run transversely with respect to this, the hatch can be completely closed, while creating the fence-like protection around the hatch during opening, by appropriate arrangement of the pivoting axes on the flap.

For this purpose, those subsections of each flap which project upward are likewise provided with cylindrical segments on their lower faces, which cylindrical segments form the fence-like protection, while at the same time closing the gap between the opened flap and the edge area of the hatch, when the flap is in the open position.

All means and measures are provided such that the traction batteries can be replaced and the flaps can be operated in an automated form.

In one alternative invention, the invention makes it possible for the fence-like protection for the hatch to be formed by a flexible bellows or a flexible-tube bead which clasps the edges of the hatch, and forms the fence-like protection for the hatch opening, when in the activated position. A bellows or flexible tube such as this can be inflated as soon as the hatch is opened, thus providing protection against anything falling in. The bellows or the bead can be folded by allowing air to escape when the hatch is closed, such that the electric vehicle drive on to it. Both measures, the flaps which can be pivoted and are provided for closing and opening the hatch, and the flexible bellows surrounding the open hatch, or the flexible-tube bead, can be used in conjunction with one another.

The present invention offers a range of advantages. For example, the proposed measures make it possible to shorten the time required to replace a traction battery by several times, because sensible devices allow fully automatic operation. Different vehicles with different track widths and/or different tire widths can be handled by a single mechanism, which at the same time compensates for position tolerances.

Freedom from disturbances is largely ensured by the driver of the electric vehicle no longer being involved in the automatic process after driving into the replacement station; the position and the replacement of the traction battery are carried out under process control, taking account of the specific vehicle dimensions, if appropriate after correction of the track guidance or the vehicle position before entering the replacement station. In order to achieve a high safety standard, measures are provided within the automatic process to prevent hazards to people.

Other features which are considered as characteristic for the invention are set forth in the appended claims.

Although the invention is illustrated and described herein as embodied in a replacement station for the traction batteries of electric vehicles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a plan view of a replacement station according to the invention;

FIG. 2 is a vertical section through a replacement station according to the invention, as shown in FIG. 1;

FIG. 3 shows a plan view of an electric vehicle as it is related to the invention;

FIG. 4 shows a rear view of an electric vehicle above the hatch;

FIG. 5 shows the functional layout of a replacement station; and

FIGS. 6-8 show schematic views of the open and closed hatches.

### DETAILED DESCRIPTION OF THE INVENTION

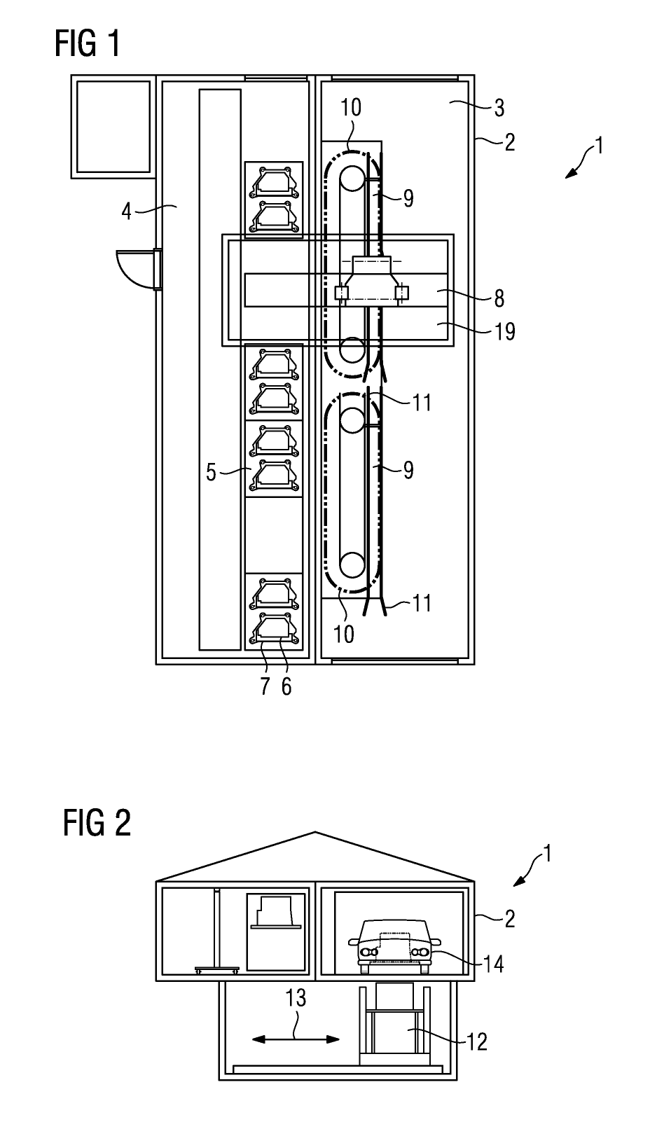

Referring now to the figures of the drawing in detail and first, particularly, to FIG. 1 thereof, there is shown a highly schematic illustration of a replacement station 1 for the traction batteries of electric vehicles, showing a building 2 which is subdivided into two rooms. The electric vehicle can be driven into the right-hand room 3 in the drawing figure, while a shelf system 5, which is not described in any more detail, with an associated handling apparatus for storing and handling the traction batteries 6 is accommodated in the left-hand room 4 in the drawing. The traction batteries 6 are each arranged in replacement frames 7, and are replaced together with them. The replacement is carried out through a hatch in the floor, which can be seen at 8 in the right-hand room 3. When there is no electric vehicle in the room, the hatch 8 is closed for safety reasons, and can be opened manually or automatically, as will also be explained later.

Traction batteries for electric vehicles or hybrid vehicles are also referred to as electric vehicle batteries (EVB) and electric vehicles are also referred to as propulsion battery electric vehicles (BEV).

FIG. 1 also shows the track guide 9 for the electric vehicle 14 in the right-hand room 3, which track guide 9 is provided with a towing chain 10 in the exemplary embodiment. As known from car washes, the endlessly running towing chain engages behind at least one of the wheels 24 of the electric vehicle 14, and moves it through the track guide 9. In the exemplary embodiment, the track guide 9 is provided only for the wheels 24 of one side of the vehicle; the track guide itself consists of guide rails with side guides 11, to which the flank areas of the guided wheels can be applied. The position of the towing chain 10 is controlled as a function of the vehicle, and positions the electric vehicle such that the traction battery 6 to be replaced is positioned exactly above the initially still closed hatch 8.

As can be seen in FIG. 2, a handling apparatus 12 is arranged under the hatch 8 and allows the traction battery 6 to be removed downward when the hatch 8 is open, and to be transported by lateral movement (direction of the arrow 13) into the area of the shelf system 5, where the discharged traction battery 6 is replaced by a charged battery. In this case, it is always absolutely essential that the handling apparatus 12 and the traction battery 6 be positioned exactly for replacement, in order to allow the traction battery 6 to be removed and fitted together with its frame 7.

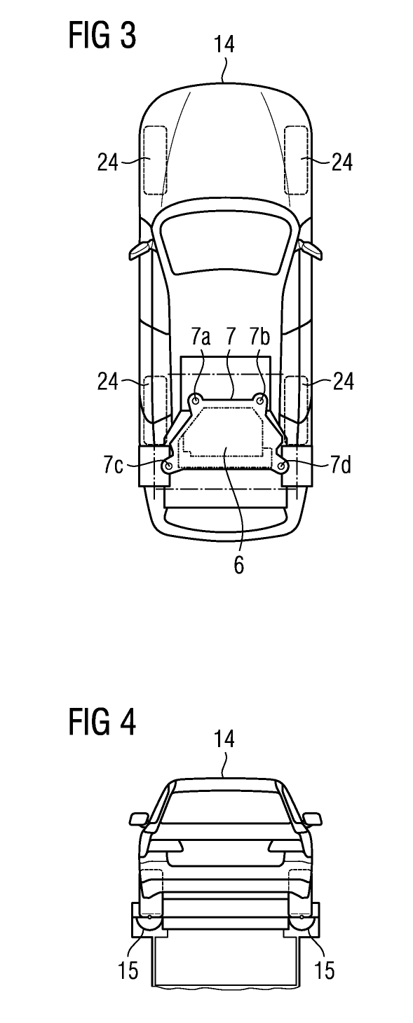

As can be seen in FIG. 3, which shows a schematic plan view of an electric vehicle 14, the traction battery 6 is in principle arranged in a replaceable frame 7, which is attached to four attachment points 7a to 7d under the electric vehicle 14, behind the wheels 24 on the rear axle in the direction of travel. In order to fully utilize the capacity of the traction battery 6, it is relatively large, as a result of which the replaceable frame 7 is broader than the track width of the electric vehicle 14. This means that a sufficiently large unobstructed space must be provided within the hatch in order to replace the traction battery 6 through the hatch 8, and in the example this extends into the movement path of the electric vehicle 14. However, for safety reasons, it must be possible to close this area of the hatch 8 at least for the entrance of the electric vehicle 14.

FIG. 4 shows a schematic rear view of the electric vehicle 14 positioned above the hatch 8, having been moved to this position above flaps 15 which have a semicircular cross section. In order to allow the electric vehicle 14 to enter, the flaps close at least that part of the hatch 8 which extends into the movement path of the electric vehicle 14. The flaps 15 can pivot, as will also be explained later.

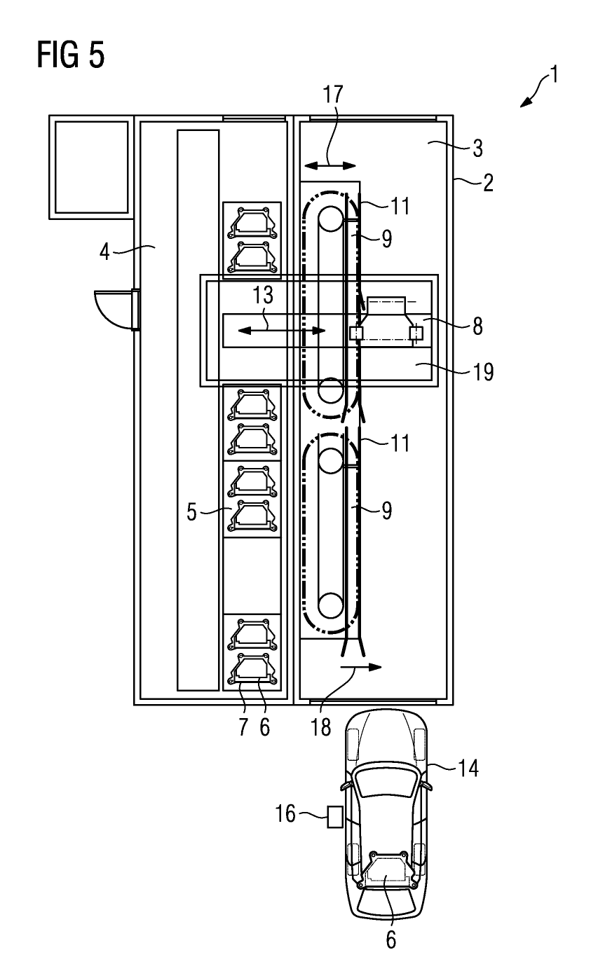

FIG. 5 once again shows a schematic plan view of the replacement station 1 in its totality. The electric vehicle 14 is in front of the entrance to the replacement station, from where it can communicate with the computer system for the automatic station. The driver of the electric vehicle 14 registers on a terminal 16 before entering the replacement station 1. Vehicle data which is stored in the computer, has previously been measured or is entered in the terminal is first of all checked to determine whether the track width of the electric vehicle 14 will pass over the hatch opening, that is to say whether the traction battery can be positioned exactly above the hatch 8 once the electric vehicle 14 has been moved in. Changes to this position can be carried out by moving the track guide 9 in its totality, as indicated by the double-headed arrow 17, transversely with respect to the longitudinal axis of the electric vehicle 14, such that the longitudinal axis of the electric vehicle 14 is moved laterally as appropriate. A similar adjustment process is carried out for the tire width of the electric vehicle 14, by laterally moving at least one of the side guides 11 of the track guide 9, as indicated by the arrow 18, and setting it to a width in which the side flanks of the tires of the electric vehicle 14 rest on the side guides 11 on both sides, such that they are guided exactly.

The double-headed arrow 13 in FIG. 5 likewise symbolizes that a handling apparatus (12 in FIG. 2), by means of which the traction batteries 6 can be replaced, can be moved under the floor in a passage 19 which connects the hatch 8 to the shelf store 5. The shelf store 5 is itself controlled by a shaft controller, which is not illustrated, whose function need not be described any further here.

For safety reasons, the replacement station 1 provides for the hatch 8 through which the traction battery 6 is replaced to be closed when no electric vehicle 14 has entered. As soon as the electric vehicle 14 is positioned above the hatch 8, the latter is opened, as will be described in the following text.

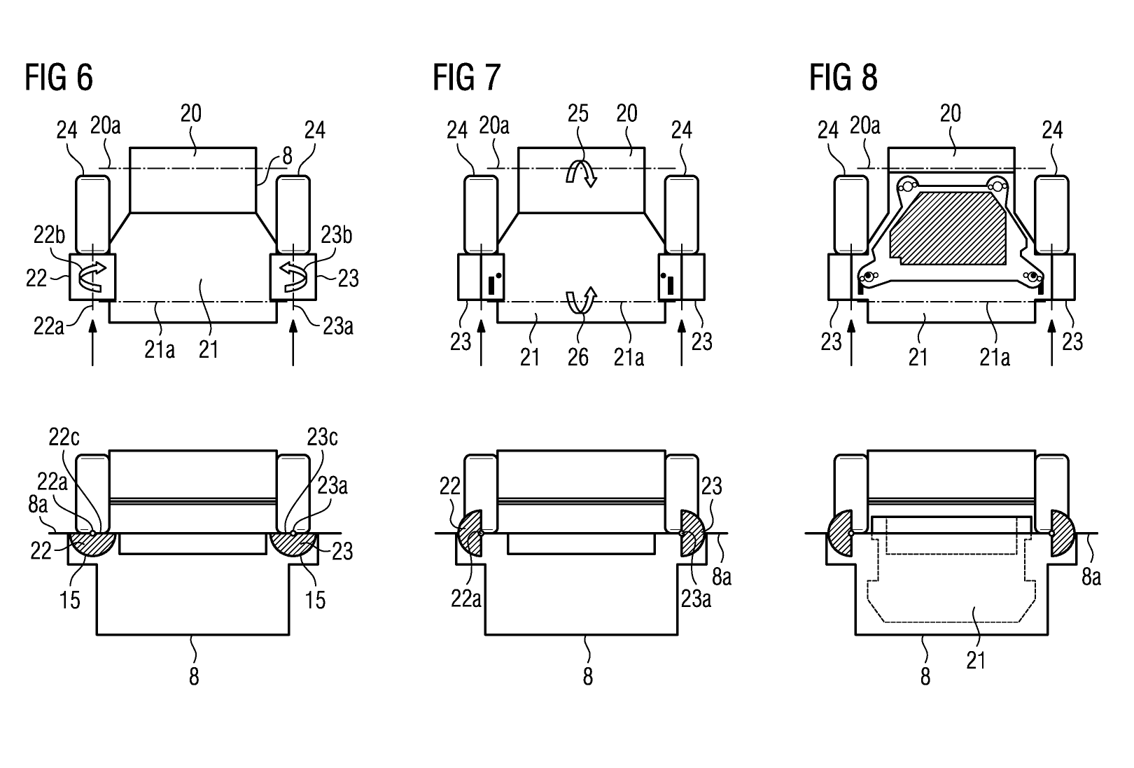

FIGS. 6 to 8 illustrate the individual steps for opening the hatch 8, in which case the upper drawing figure in each case shows a highly schematic plan view of the area of the hatch 8, and the lower illustration in each case shows a cross section through the hatch 8, on a vertical section plane behind the rear tire of the electric vehicle 14. The plan view in the upper illustration in FIG. 6 shows four flaps 20, 21, 22, 23, by means of which the hatch 8 is closed. Each of the four flaps 20 to 23 can pivot about a horizontal axis 20a, 21a, 22a and 23a (running on the plane of the drawing). The curved arrows 22b and 23b in the two side flaps 22 and 23 are intended to show that the flaps 22 and 23 can be pivoted about their axes 22a and 22b at a time after the track-guided entrance of the electric vehicle 14 into the battery replacement position, in order to allow the free space required at the side for replacement of the traction battery 6 together with its replaceable frame 7. The two side flaps 22 and 23 are arranged behind the rear wheels 24 in the area of the track of the electric vehicle 14, and allow the electric vehicle 14 to drive over them when the flaps 22 and 23 are in the closed position.

This situation is illustrated in the lower drawing in FIG. 6, which also shows that the side flaps 22 and 23 are half-cylindrical 25 (with a semicircular cross section) on their lower faces, which on the one hand provides robustness for driving over these flaps 22 and 23, while on the other hand ensuring that the gap to the edge 8a of the hatch 8 remains closed when the flaps 22 and 23 are being opened, as is shown in the lower illustration in FIG. 7.

As can be seen in FIG. 7, after the electric vehicle 14 has entered, the flaps have been pivoted through 45° about their axes 22a and 23a, as a result of which the upper faces 22c and 23c of the flaps 22 and 23 which can be driven on are now positioned more vertically, and the opening of the hatch 8 has been considerably enlarged. At the same time or in a second step, the two other flaps 20 and 21 are pivoted about their pivoting axes 20a and 21a as indicated by the arrows 25 and 26, in order to also open the larger part of the hatch 8. The pivoting axes 20a and 21a of the flaps are arranged such that these flaps 20 and 21 also provide fence-like protection for the hatch opening, simply by being rotated through 45° to a vertical position. As can be seen in the upper illustration in FIG. 8, this now results in an opening of adequate size to install and remove the traction battery 6 with its replaceable frame 7.

As is shown in the lower illustration in FIG. 8, after the pivoting of the flaps 20, a sub-area of the flap 20 has been positioned at the top in the direction of the bottom of the vehicle, as a consequence of the sensible arrangement of the pivoting axis 20a, and projects beyond the edge 8a of the hatch 8, thus forming the safety fence. This is also done with the second flap 21, which is illustrated only by dashed lines in the lower part of FIG. 8 because it is concealed by the front flap 20. The flap 21 also pivots about a sensibly arranged pivoting axis 21a, as a result of which that part of the flap 21 which projects upward beyond the edge 8a of the hatch 8 forms fence-like protection for the hatch 8, to prevent people and objects falling into it.

Together with the side flaps 22 and 23, which are likewise pivoted to a vertical position, the flaps 20 and 21 form a virtually complete fence around the hatch 8 when the hatch 8 is open, preventing objects or living beings from falling into the shaft under the hatch. The sub-areas of the flaps 20 and 21 which project beyond the hatch edge 8a are preferably likewise half-cylindrical or quarter-cylindrical (this cannot be seen in the view in FIG. 8), as a result of which, the gap between the flap 20 and/or 21 and the hatch 8 is also closed in the pivoted position here.

1. A replacement station for exchanging traction batteries of electric vehicles, wherein the batteries are arranged for replacement from underneath the vehicle, alongside a vehicle axis in a direction of travel, in a floor area of the electric vehicle, the replacement station comprising:
a hatch provided in a floor of the replacement station and formed to have the electric vehicle disposed thereabove;
a track guidance system for guiding the vehicle during positioning above said hatch, said track guidance being configured to guide at least those wheels that are arranged on one longitudinal side of the electric vehicle;
a controlled external drive acting on the electric vehicle, at least during track guidance, for automatically moving the electric vehicle; and
wherein the traction battery is replaced through said hatch after the vehicle has been positioned.

2. The replacement station according to claim 1, wherein said external drive comprises a towing chain configured to act on the wheels of the electric vehicle driving them forward, and to transport the electric vehicle with the traction battery exactly to a position above the hatch.

3. The replacement station according to claim 1, wherein said track guidance is laterally adjustable within the replacement station with respect to the longitudinal axis of the electric vehicle, with respect to at least one of a wheel width or a track width of the electric vehicle, to enable the traction battery of the electric vehicle to be positioned centrally above the hatch, irrespective of the wheel width and/or the track width.

4. The replacement station according to claim 1, wherein said track guidance comprises a guide rail with side guides on both sides, to which the flank areas of the guided wheels can be applied.

5. The replacement station according to claim 4, wherein said side guides have an adjustable lateral distance therebetween, for adjusting to a width of the wheels or of the tires of the vehicle.

6. The replacement station according to claim 4, wherein said one or both of said track guide and said side guide are laterally adjustable on a basis of known vehicle dimension data and a known position of the traction battery within the electric vehicle.

7. The replacement station according to claim 6, wherein, before the electric vehicle is moved into the replacement station, the vehicle dimension data are recorded and the vehicle dimension data are entered into a computer controlling a matching of the track guide to the individual dimensions of the electric vehicle.

8. The replacement station according to claim 1, which further comprises aids for an initial positioning of the electric vehicle in front of said track guide.

9. The replacement station according to claim 8, wherein said aids for initial positioning of the electric vehicle are movement platforms that are guided on the floor and on which the electric vehicle thereon can be moved, by lateral movement of the movement platforms, to a position which corresponds to an entrance position into the track guide.

10. The replacement station according to claim 1, wherein said hatch is kept closed prior to the positioning of the electric vehicle, and said hatch is opened once the electric vehicle has been positioned exactly above said hatch.

11. The replacement station according to claim 1, which comprises a plurality of flaps for closing said hatch, said flaps being pivotally mounted about respective horizontal pivoting axes.

12. The replacement station according to claim 11, wherein edge areas of said hatch form a protective fence when said pivoted flaps are in the open position.

13. The replacement station according to claim 12, wherein subsections of said pivoted flaps that project upward above the floor level form said protective fence for the edge areas of said hatch when in their open positions.

14. The replacement station according to claim 11, wherein, with a hatch width extending into the driving track of the electric vehicle, flaps are provided that can be moved over on both sides in an edge area of the hatch and can be pivoted about pivoting axes that are arranged parallel to the vehicle longitudinal direction, after the flaps have been moved over and prior to the replacement of the traction battery.

15. The replacement station according to claim 14, wherein, when the flaps are closed, their upper faces each form a flat movement path for the electric vehicle, and in that, at least that area of the lower faces of each of the two flaps facing the edge of the hatch is in the form of a cylindrical segment, whose longitudinal center axis in each case coincides with the pivoting axis of the flap, wherein, when the flap is being pivoted to the open position of the hatch, that cylindrical segment which faces outward is pivoted upward, and forms the fence-like protection for the opening of the hatch.

16. The replacement station according to claim 14, which further comprises one or two further flaps, pivotable for closing said hatch, about pivoting axes that run parallel to an edge area of said hatch and transversely with respect to the vehicle longitudinal axis and positioned with respect to the flap or flaps such that a subsection of each flap projects above a floor level in an immediate edge area of the hatch, when pivoted to the open position, and forms the protective fence for said hatch.

17. The replacement station according to claim 16, wherein those subsections of each flap which project upward are provided with cylindrical segments on their lower faces, which cylindrical segments form the protective fence, while at the same time closing the gap between the opened flap and the edge area of the hatch, when the flap is in the open position.

18. The replacement station according to claim 12, wherein the protective fence for said hatch is provided by a flexible bellows or a flexible-tube bead, which clasps the edges of the hatch, and forms the fence-like protection for the hatch opening, when in the activated position.

19. The replacement station according to claim 1, wherein said flaps which can be pivoted and are provided for closing and opening the hatch, are supplemented by the flexible bellows, which surround the open hatch, or the flexible-tube bead.

20. A method for exchanging traction batteries of electric passenger vehicles, wherein the batteries are arranged for replacement from underneath the vehicle, alongside a vehicle axis in a direction of travel, in a floor area of the electric vehicle, the method which comprises:
positioning the electric vehicle above a hatch provided in a floor of the replacement station;
during positioning, guiding the vehicle with track guidance guiding at least those wheels that are arranged on one longitudinal side of the electric vehicle and, at least during track guidance, automatically moving the electric vehicle by a controlled external drive acting on the electric vehicle; and
subsequent to positioning, replacing the traction battery through the hatch.
